(19) United States
(12) Patent Application Publication
(10) Pub. No.: US 2019/0042332 A1
(43) Pub. Date: Feb. 7, 2019

(54) HARDWARE LOCKING PRIMITIVE SYSTEM FOR HARDWARE AND METHODS FOR GENERATING SAME

(71) Applicant: Next Silicon, Ltd., Tel Aviv (IL)

(72) Inventors: Elad RAZ, Ramat Gan (IL); ILAN TAYARI, Tzur Hadassah (IL)

(73) Assignee: Next Silicon, Ltd., Tel Aviv (IL)

(21) Appl. No.: 16/052,395

(22) Filed: Aug. 1, 2018

Related U.S. Application Data
(60) Provisional application No. 62/540,856, filed on Aug. 3, 2017.

(51) Int. Cl. G06F 9/52; G06F 9/54; G06F 9/48

(52) U.S. Cl. CPC G06F 9/526; G06F 9/485; G06F 9/546

(57) ABSTRACT

A method for implementing locking primitive in a computing architecture is provided. In an embodiment, the method includes receiving a first request to lock operation from a special hardware cell of the computing architecture from a first thread at a first-time pointer; receiving a second request from a second thread at a second-time pointer to a lock operation from the special hardware cell, wherein the first-time pointer is earlier than the second-time pointer; enabling the first thread to read from the special hardware cell and continuing execution of the first thread; and upon identification of an unlock request by the first thread, enabling the second thread to lock from the special hardware cell and continuing execution of the second thread.

### CROSS-REFERENCE TO RELATED APPLICATIONS

This application claims the benefit of U.S. Provisional Application No. 62/540,856 filed on Aug. 3, 2017, the contents of which are hereby incorporated by reference.

### TECHNICAL FIELD

The disclosure generally relates to computing system architectures, and more specifically to embedded computing architecture and optimization thereof.

### BACKGROUND

In computing systems, shared memory may be utilized to pass information from one execution thread to another, or allow access to a shared resource. This requires coordination of access to the shared resource between threads using a locking primitive.

An example use case for locking primitive is via a busy-lock or ‘mutex’ (mutual exclusion object). In such a case, a synchronization mechanism is utilized for enforcing limits on access to a resource in an environment where there are many threads of execution. A lock is designed to enforce a mutual exclusion concurrency control policy.

Generally, locks are advisory locks, where each thread cooperates by acquiring the lock before accessing the corresponding data. Some computing systems also implement mandatory locks, where attempting unauthorized access to a locked resource forces an exception in the entity attempting to make the access.

The simplest type of lock is a binary semaphore. It provides an exclusive access to a locked resource (or data). Other locking schemes also provide shared access for reading data. Other widely implemented access modes are exclusive, intend-to-exclude and intend-to-upgrade.

Another way to classify locks is by what happens when the lock strategy prevents progress of a thread. Most locking designs typically block the execution of the thread requesting the lock until the thread is permitted to access the locked resource. With a spinlock (also known as busy-lock), the thread simply waits (‘spins’) until the lock becomes available by lock exchange of the shared memory value, which indicates whether the lock is free or not. The spinlock is efficient when threads are blocked for a short time, where operating system overhead re-scheduling the threads are avoided. In an embodiment, it is inefficient if the lock is held for a long time, or if the progress of the thread that is holding the lock depends on preemption of the locked thread.

However, lock-based resource protection and thread/process synchronization have many disadvantages. For example, resource contention may occur when some threads/processes have to wait until a lock (or a whole set of locks) is released. An additional disadvantage is associated with debugging where bugs associated with locks are time dependent and can be very subtle and extremely hard to replicate, such as deadlocks.

Another disadvantage of lock-based resource protection is instability. That is, the optimal balance between lock overhead and lock contention can be unique to the problem domain (application) and sensitive to design, implementation, and even low-level system architectural changes. These balances may change over the life cycle of an application and may entail tremendous changes to update (re-balance). Additional disadvantage is lock-based resource protection is the convoy effect which causes all threads to wait until a thread holding a lock is de-scheduled due to a time-slice interrupt or page fault.

Thus, it would be advantageous to provide a lock-based resource protection mechanism that overcomes the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

The various aspects of the disclosed embodiments include a method for implementing locking primitive in a computing architecture. The method comprises receiving a first request for lock operation from a special hardware cell, for example memory read operation on a memory cell, of the computing architecture from a first thread at a first-time pointer; receiving a second request from a second thread at a second-time pointer to read from the special hardware cell, wherein the first-time pointer is earlier than the second-time pointer; enabling the first thread to read from the special hardware cell and continuing execution of the first thread; and upon identification of a unlock operation, for example a memory write request, by the first thread, enabling the second thread to read from the special hardware cell and continuing execution of the second thread.

The various aspects of the disclosed embodiments include a computing architecture, comprising: a processing circuitry; and a memory containing a plurality of special hardware cells, the special hardware further containing instructions that, when executed by the processing circuitry, configure the computing architecture to: receive a first request for operation, for example, to read or to write from a special hardware cell of the computing architecture from a first thread at a first-time pointer; receive a second request from a second thread at a second-time pointer to read or to write from the special hardware cell, wherein the first-time pointer is earlier than the second-time pointer; enable the first thread to read or to write from the special hardware cell and continue the execution of the first thread; and upon identification of a corresponding operation request by the first thread, enable the second thread to perform the operation from the special hardware cell and continue execution of the second thread.

### BRIEF DESCRIPTION OF THE DRAWINGS

The subject matter disclosed herein is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic diagram of a cache coherence embodiment.

FIG. 2 is a flowchart of locking primitive according to an embodiment.

### DETAILED DESCRIPTION

In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In an embodiment, the disclosed solution allows system calls (or requests) by clients to reach deliberately or inadvertently a memory while increasing the runtime performance.

According to the disclosed embodiments that solution is realized by a system and method that enable optimization of a hardware performance by implementing locking primitive of memory readings based on certain heuristics. Such implementation enables synchronization of software/threads run.

In an embodiment, the system is configured to receive a first and at least a second request for a lock operation from a certain memory of a computing architecture from a first client at a first-time pointer and at least a second client at a second-time pointer. The first-time pointer is earlier than the second-time pointer. Then, the system enables the first client to operate from the certain special hardware cell. Thereafter, the system enables the at least a second cell to operate from the certain special hardware cell only upon identification of an unlock operation of the first client. According to another embodiment, the system can further synchronize the threads and/or processes in the hardware by scheduling them at a wait queue implemented therein.

In an embodiment, a method for implementing a locking primitive in a computing architecture is provided. The method includes receiving a first request to lock from a certain memory of a computing architecture from a first client at a first-time pointer and at least a second request from a second client at a second time pointer to lock from the certain memory wherein the first time pointer is earlier than the second time pointer; enabling the first client to operate from the certain special hardware cell and continue its execution; and enabling the at least a second client to lock from the certain special hardware cell, and continue its execution, only upon identification of an unlock operation of the first client.

In an embodiment, the method further includes blocking execution of the at least a second client via methods of flow control of the underlying transport.

In an embodiment, the methods of flow control include pause frames, ACK/NACK (acknowledgment/negative-acknowledgment), ready signal, and/or request to send/clear to send (CTS/RTS).

In an embodiment, the computing architecture is a reconfigurable hardware.

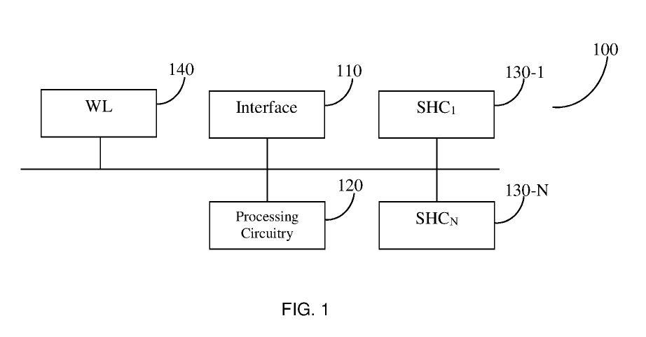

FIG. 1 is an example block diagram of a computing architecture 100 utilized to disclose the various embodiments. The computing architecture 100 includes an interface 110 via which the computing architecture 100 can receives a plurality of requests from a plurality of memory clients. According to an embodiment, the computing architecture 100 may be embedded in a reconfigurable hardware. The reconfigurable hardware can work on any hardware, including CPU cores, GPUs, neural-networks, Coarse-Grained Reconfigurable Architectures (CGRA), and the like.

The computing architecture 100 further comprises a processing circuitry 120. The processing circuitry 120 is configured to manage requests received from different clients via the interface 110. The computing architecture 100 further includes a plurality of special hardware cells (SHCs) 130-1 through 130-N where N is an integer equal to or greater than 1. The SHCs 130 are 1, 8, 16, 32, 64, 128, 256, 512-bits or a word size that is accessible in the system individually. For example, a load/store to a specific address equals a size of a special hardware cell.

According to an embodiment, the computing architecture 100 is configured to receive via the interface 110 a first request from a first thread (issued by a first client) to operate from a certain portion of the memory. That is, from a special hardware cell, for example SHC 130-1. The request is received at a first-time pointer. The computing architecture 100 is further configured to receive via the interface 110 another request (a second request) from a different thread (issued by different (second) client) at a second-time pointer to read data from the same special hardware cell the first request is directed from (e.g., SHC 130-1). Each of the first-time and second-time pointers refer to certain point in time. In an embodiment, the first-time pointer is earlier than the second-time pointer.

According to the disclosed embodiments, in order to enable the locking primitive, the processing circuitry 120 is configured to enable a first thread to operate from the requested special hardware cell (e.g., SHC 130-1), for each to read therefrom. The operation of the first thread is monitored, by the processing circuitry 120, and upon identification of a write of the first thread to a different location (e.g., another SHC or a different thread), the second thread is enabled to read from the requested special hardware cell (e.g. SHC 130-1). It should be noted that prior to a write operation by the first thread, the read request is placed on a wait state or on a freeze state. Alternatively, the second thread may continuously retry to perform a read operation, until such operation is enabled by the processing circuitry 120.

In another embodiment, when the locking primitive is enabled by the processing circuitry 120, the second thread is blocked from execution of processes. This can be performed, for example, using a flow control method, such as, but noted limited, pause frames, ACK/NACK, ready signal, CTS/RTS, and the like.

In an embodiment, the locking primitive, disclosed herein, further includes implementation of a synchronization mechanism. Such a mechanism may include, for example, a mutex lock (mutual exclusion), a semaphore lock, a critical section lock, a read-lock, a write-lock or a combination thereof. The synchronization mechanism enforces limits on access to a certain special hardware cell. The lock is designed to enforce a mutual exclusion concurrency control policy. That is, all threads that attempt to access via a different read operation are stalled until the first thread releases the lock via a write command.

In an embodiment, when the synchronization mechanism is implemented as a semaphore, a locked request (e.g., a request in a lock state) is placed in a waiting list (WL). In an example configuration, the waiting list is implemented in the computing architecture 100 as a hardware component 140.

The waiting list includes all the information needed by the waiting thread(s) for cases where a lock cannot be obtained. Thereafter, when the lock is released, a thread is recovered from the waiting list (obtained from hardware component 140) and processed. It should be noted that the threads perform the operation.

In some configurations, in case the computing architecture 100 is implemented in a reconfigurable hardware, a plurality of processors or flow-processors, the operation flow stops once the request is placed in the waiting list. In such a configuration, a request is released from the waiting list only upon determination that the request special hardware cell (e.g., SHC 130-1) is available. Therefore, only a single request is forwarded and additional requests from same special hardware cell (e.g., SHC 130-1) are kept in the waiting list 140 until an indication that the special hardware cell is ready to receive additional requests.

It should be emphasized that the locking primitive when two different clients attempt to access the same resource (special hardware cell) substantially at the same time.

The computing architecture 100 may be any one of a field-programmable gate array (FPGA), a graphics processing unit (GPU), an application-specific integrated circuit (ASIC), a quantum computer, a coarse-grained reconfigurable architecture (CGRA), optical computing, a Neural-Network accelerator or a combination thereof, and portions thereof. As noted above the computing architecture 100 may be also a reconfigurable hardware.

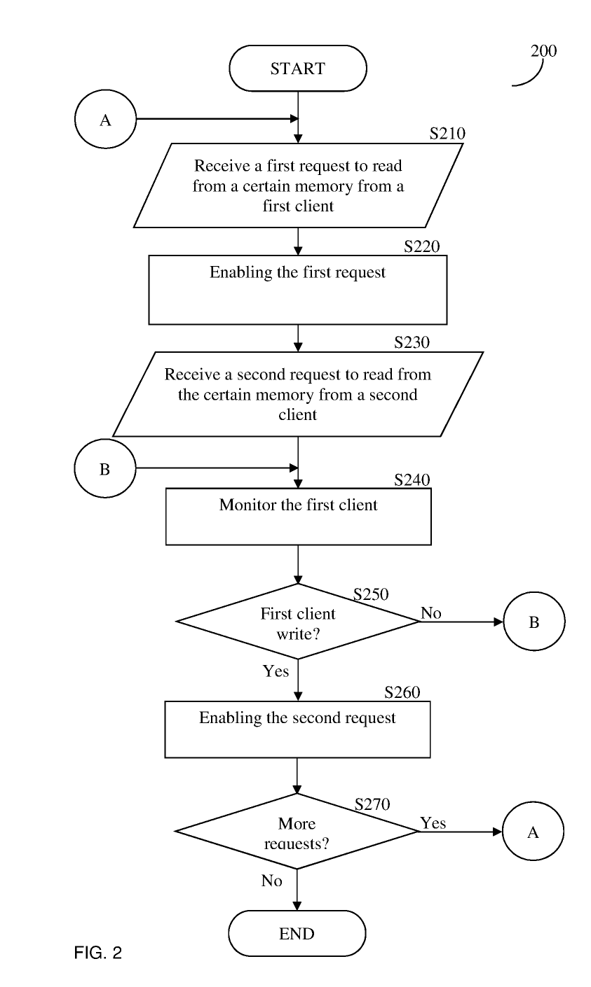

FIG. 2 shows an example flowchart 200 illustrating a method for operating a locking primitive in a computing architecture according to an embodiment. At S210, the operation starts when a first request from a certain special hardware cell is received from a first client at a first-time pointer. The request may be, for example, to read from the certain special hardware cell.

At S220, the first client is enabled by the computing architecture 100 to read from the certain special hardware cell. At S230, a second request to read from the certain special hardware cell is received from a second client at a second-time pointer. The first-time pointer is earlier than the second-time pointer. The first and second read requests are triggered and executed in the computing architecture threats.

At S240, the operation of the first client is monitored by the computing architecture. It should be noted that while the first client is enabled to read from the certain special hardware cell, the second client either freezes and waits for the read to succeed or continuously retries to read the certain memory.

At S250, it is checked whether a write operation by the first client has been performed. If so, execution continues with S260; otherwise, execution returns to S240. At S260, upon identification of a write operation by the first client, a read of the certain special hardware cell is enabled by the second client. At S270, it is checked whether additional requests have been received and if so, execution continues with S210; otherwise, execution terminates.

The embodiments disclosed herein can be implemented as hardware, firmware, software, or any combination thereof. The application program may be uploaded to, and executed by, a machine comprising any suitable architecture. Preferably, the machine is implemented on a computer platform having hardware such as one or more central processing units (“CPUs”), a memory, and input/output interfaces.

The computer platform may also include an operating system and microinstruction code. The various processes and functions described herein may be either part of the microinstruction code or part of the application program, or any combination thereof, which may be executed by a CPU, whether or not such computer or processor is explicitly shown.

In addition, various other peripheral units may be connected to the computer platform, such as an additional data storage unit. Furthermore, a non-transitory computer readable medium is any computer readable medium except for a transitory propagating signal.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for implementing locking primitive in a computing architecture, comprising:
receiving a first request to lock operation from a special hardware cell of the computing architecture from a first thread at a first-time pointer;
receiving a second request from a second thread at a second-time pointer to a lock operation from the special hardware cell, wherein the first-time pointer is earlier than the second-time pointer;
enabling the first thread to a lock operation from the special hardware cell and continuing execution of the first thread; and
upon identification of an unlock request by the first thread, enabling the second thread to lock from the special hardware cell and continuing execution of the second thread.

2. The method of claim 1, wherein enabling the first thread to operate from the special hardware cell further comprises:
blocking execution of the second thread from execution.

3. The method of claim 2, wherein blocking the execution is performed using at least one flow control of the underlying transport technique.

4. The method of claim 3, wherein the underlying transport technique includes any one of: pause frames, acknowledgment/negative-acknowledgment (ACK/NACK), a ready signal, and a request to send/clear to send (CTS/RTS).

5. The method of claim 1, further comprising:
synchronizing execution of the first thread and the second thread using a synchronization mechanism.

6. The method of claim 5, wherein the synchronization mechanism is at least one of: a mutual exclusion, a semaphore lock, a read-lock, a write-lock, and a critical section.

7. The method of claim 6, wherein the synchronization mechanism is a semaphore lock, and wherein enabling the first thread to operate from the special hardware cell, further comprises
placing the second thread in a waiting list.

8. The method of claim 7, wherein enabling the second thread to operate from the special hardware cell, further comprises:
recovering the second thread from the waiting list; and
processing the second thread.

9. The method of claim 1, wherein the first thread and the second thread are issued by different clients.

10. The method of claim 1, wherein the second thread includes a plurality of different threads.

11. The method of claim 1, wherein the computing architecture is a reconfigurable hardware.

12. The method of claim 1, wherein the computing architecture is at least one of: a central processing unit (CPU), a field-programmable gate array (FPGA), a graphics processing unit (GPU), an application-specific integrated circuit (ASIC), a quantum computer, and a coarse-grained reconfigurable architecture (CGRA), optical computing, a Neural-Network accelerator, a combination thereof.

13. A computer readable medium having stored thereon instructions for causing a processing circuitry to execute the computerized method according to claim 1.

14. A computing architecture, comprising:
a processing circuitry; and
a memory containing a plurality of special hardware cells, the memory further containing instructions that, when executed by the processing circuitry, configure the computing architecture to:
receive a first request to lock operation from a special hardware cell of the computing architecture from a first thread at a first-time pointer;
receive a second request from a second thread at a second-time pointer to lock from the special hardware cell, wherein the first-time pointer is earlier than the second-time pointer;
enable the first thread to operate from the special hardware cell and continue the execution of the first thread; and
upon identification of an unlock request by the first thread, enable the second thread to lock from the special hardware cell and continue execution of the second thread.

15. The computing architecture of claim 14, wherein the computing architecture is further configured to:
block execution of the second thread from execution.

16. The computing architecture of claim 15, wherein blocking the execution is performed using at least one flow control of the underlying transport technique.

17. The computing architecture of claim 16, wherein the underlying transport technique includes any one of: pause frames, acknowledgment/negative-acknowledgment (ACK/NACK), a ready signal, and request to send/clear to send (CTS/RTS).

18. The computing architecture of claim 14, wherein the computing architecture is further configured to:
synchronize execution of the first thread and the second thread using a synchronization mechanism.

19. The computing architecture of claim 18, wherein the synchronization mechanism is at least one of: a mutual exclusion, a semaphore lock, a read-lock, a write-lock and a critical section.

20. The computing architecture of claim 19, wherein the synchronization mechanism is a semaphore lock, and wherein the computing architecture is further configured to:
place the second thread in a waiting list.

21. The computing architecture of claim 1, wherein the computing architecture is further configured to:
recover the second thread from the waiting list; and
process the second thread.

22. The computing architecture of claim 14, wherein the first thread and the second thread are issued by different clients.

23. The computing architecture of claim 14, wherein the second thread includes a plurality of different threads.

24. The computing architecture of claim 14, wherein the computing architecture is a reconfigurable hardware.

25. The computing architecture of claim 14, wherein the computing architecture is at least one of: a central processing unit (CPU), a field-programmable gate array (FPGA), a graphics processing unit (GPU), an application-specific integrated circuit (ASIC), a quantum computer, and a coarse-grained reconfigurable architecture (CGRA), optical computing, a Neural-Network accelerator, a combination thereof.
